(19) United States
(12) Patent Application Publication
(10) Pub. No.: US 2016/0196924 A1
(43) Pub. Date: Jul. 7, 2016

(54) METHOD FOR MANUFACTURING SOLID ELECTROLYTIC CAPACITOR

(71) Applicant: Murata Manufacturing Co., Ltd., Nagaokakyo-shi (JP)

(72) Inventors: HIROSHI TOKUHARA, Nagaokakyo-shi (JP); Osamu Yokokura, Nagaokakyo-shi (JP)

(21) Appl. No.: 15/070,392

(22) Filed: Mar. 15, 2016

Related U.S. Application Data
(63) Continuation of application No. PCT/JP2014/061506, filed on Apr. 24, 2014.

(30) Foreign Application Priority Data
Sep. 20, 2013 (JP) 2013-195171

(51) Int. Cl. H01G 9/00

(52) U.S. Cl. CPC H01G 9/0032

(57) ABSTRACT

A method for manufacturing a solid electrolytic capacitor having an electrically conductive polymer layer. In the method, a first electrically conductive polymer layer is formed by a dipping method so as to at least fill pores of a rough surface part of a valve metal substrate. The valve metal substrate with the first electrically conductive polymer layer formed thereon is disposed so as to be opposed to a discharge nozzle for discharging an application material. An electric field is then generated between the discharge nozzle and the valve metal substrate. The application material is then discharged from the discharge nozzle, and the discharged application material travels along lines of electric force toward the valve metal substrate so as to form a second electrically conductive polymer layer.

### CROSS REFERENCE TO RELATED APPLICATIONS

The present application is a continuation of International application No. PCT/JP2014/061506, filed Apr. 24, 2014, which claims priority to Japanese Patent Application No. 2013-195171, filed Sep. 20, 2013, the entire contents of each of which are incorporated herein by reference.

### FIELD OF THE INVENTION

This invention relates to a method for manufacturing a solid electrolytic capacitor, and more particularly, to a method for forming an electrically conductive polymer layer included in a solid electrolytic capacitor.

### BACKGROUND OF THE INVENTION

In recent years, higher performance, smaller sizes, and lower profiles have been required for electronic components, and there has been a need to produce thinner films for electrodes as one of the means for the requirement. As far as solid electrolytic capacitors are concerned, thinner films have been also required, for example, for electrically conductive polymer layers formed in cathode regions of the capacitors to function as solid electrolytes.

A solid electrolytic capacitor includes a valve metal substrate to serve as an anode body, which has a core part and a rough surface part formed along the surface of the core part. On a surface to serve as a cathode region in the valve metal substrate, a dielectric coating film is formed, and the electrically conductive polymer layer mentioned above is formed on the dielectric coating film.

For example, in Japanese Patent No. 3667531 (Patent Document 1), a method for manufacturing a solid electrolytic capacitor is described. In the manufacturing method described in Patent Document 1, an electrically conductive polymer layer that serves as a cathode is formed by applying a monomer solution and an oxidant solution onto a valve metal substrate with the use of a dipping method, and then carrying out polymerization from the monomer through a chemical oxidative polymerization method.

In the case of forming the electrically conductive polymer layer by a dipping method, pores of a rough surface part of the valve metal substrate with a dielectric coating film formed on the surface thereof is filled with an electrically conductive polymer, and the electrically conductive polymer layer is formed so as to cover the rough surface part. However, it is difficult to provide the electrically conductive polymer layer as a uniform thin layer under the influence of gravity and surface tension. In particular, on an edge part of the valve action metal substrate in the form of foil, the electrically conductive polymer layer is less likely to be formed.

As just described, when a thin uniform layer is not able to be formed as the electrically conductive polymer layer, the electrostatic capacitance per volume is not able to be increased, thus making it impossible to increase the capacitance, reduce the size, or lower the profile for the solid electrolytic capacitor.

In addition, when the electrically conductive polymer layer is not formed on the edge, there is a possibility that at least one of a carbon layer and a silver layer formed on the electrically conductive polymer layer will come into contact with the dielectric coating film located under the electrically conductive polymer layer to increase a leakage current value. In addition, stress during forming of an exterior resin is applied to the edge part, thus resulting in significant damage to the dielectric coating film, which can also cause an increase in leakage current value.

Patent Document 1: Japanese Patent No. 3667531

### SUMMARY OF THE INVENTION

Therefore, an object of the present invention is to provide a method for manufacturing a solid electrolytic capacitor having a uniform and thin electrically conductive polymer layer on a valve metal substrate, including on an edge part thereof.

The method includes the steps of: preparing a valve metal substrate to serve as an anode body, the valve metal substrate including a core part and a rough surface part formed along the surface of the core part; forming a dielectric coating film on at least a surface of a region, which is for a cathode, of the valve metal substrate; and forming an electrically conductive polymer layer to cover the region of the valve metal substrate with the dielectric coating film interposed therebetween.

The step of forming the electrically conductive polymer layer is carried out in two stages of: a step of forming a first electrically conductive polymer layer on the dielectric coating film to fill at least a pore of the rough surface part; and a step of forming a second electrically conductive polymer layer to cover the region of the valve metal substrate with the first electrically conductive polymer layer formed thereon.

Further, the step of forming the second electrically conductive polymer layer is characterized in that it includes the steps of: preparing an application material to be the second electrically conductive polymer layer; disposing the valve metal substrate with the first electrically conductive polymer layer formed thereof so as to be opposed to a discharge nozzle for discharging the application material; generating an electric field between the discharge nozzle and the valve metal substrate; discharging the application material from the discharge nozzle during generation of the electric field so as to cause charged application material to travel, with Rayleigh fission, along a line of electric force toward the valve metal substrate; and drying the material so as to form the second electrically conductive polymer layer and cover the region of the valve metal substrate.

The application material mentioned above can be, in preferred embodiments, a dispersion or a solution of the electrically conductive polymer, or multiple types of raw materials for producing the electrically conductive polymer by a chemical oxidative polymerization method, that is, a monomer, an oxidant, a dopant, and a solvent.

According to this invention, the charged application material travels in the air along the lines of electric force in the above-mentioned step of forming the second electrically conductive polymer layer. During this traveling, the application material repeats fission (Rayleigh fission) due to Coulomb repulsion. The surface area is increased each time fission is repeated, and thus accelerating the evaporation of a liquid component such as a medium or a solvent contained in the application material. As a result, the application material is, in adhering to the surface of the first electrically conductive polymer layer or the like, dried to the extent that the fluidity is almost lost. Therefore, no surface tension substantially acts on the application material, and the application material is thus not concentrated on any particular part.

In addition, according to this invention, the application material travels along the lines of electric force as mentioned previously in the step of forming the second electrically conductive polymer layer, and thus, the application from one direction can uniformly form the second electrically conductive polymer layer simultaneously on all of a principal surface of the valve metal substrate, and end surfaces adjacent to the principal surface with an edge part interposed therebetween. In addition, the lines of electric force have a tendency to be concentrated on, in particular, the edge part, and the second electrically conductive polymer layer can be formed on the edge part to have a thickness equal to or larger than that on the surface part. Accordingly, the difference in the electrically conductive polymer layer between the surface part and the edge part can be reduced, which is caused in the formation of the first electrically conductive polymer layer.

In this way, according to this invention, a uniform and thin electrically conductive polymer layer can be formed so as to cover the region of the valve metal substrate, including on an edge part.

Due to the fact that the electrically conductive polymer layer can be formed to be uniform and thin, a capacitor unit configured to have the valve metal substrate and the electrically conductive polymer layer can be made thinner, thereby making it possible to increase the number of capacitor units that can be disposed in the same volume. This contributes to higher capacitance, smaller sizes, and lower profiles of solid electrolytic capacitors.

In addition, due to the fact that the electrically conductive polymer layer can be formed to have an appropriate thickness on the edge part of the valve metal substrate, a carbon layer and a silver layer that are formed over the electrically conductive polymer layer can be made less likely to undesirably come into contact with the dielectric coating film present below the electrically conductive polymer layer, thereby making it possible to reduce a leakage current value. In addition, while stress in finally forming an exterior resin is applied to the edge part, damage by the stress to the dielectric coating film can be reduced, and the percent defective due to leakage current can be thus reduced.

In addition, due to the fact that the electrically conductive polymer layer can be formed to be thin and uniform, materials for use in the formation of the electrically conductive polymer layer can be reduced, and the material cost of the solid electrolytic capacitor as a product can be thus reduced.

### BRIEF EXPLANATION OF THE DRAWINGS

FIG. 1 is a cross-sectional view illustrating a solid electrolytic capacitor 10 manufactured by applying a manufacturing method according to an embodiment of this invention.

FIG. 2 is a cross-sectional view illustrating an enlargement of a part A in FIG. 1, which illustrates a first electrically conductive polymer layer 31 formed.

FIG. 3 is a cross-sectional view illustrating an enlargement of the part A in FIG. 1, which illustrates a second electrically conductive polymer layer 32, a carbon layer 25, and a silver layer 26 further formed after the formation of the first electrically conductive polymer layer 31 shown in FIG. 2.

FIG. 4 is a front view schematically illustrating the implement of a step of forming the second electrically conductive polymer layer 32.

FIG. 5 is a perspective view illustrating an enlargement of the valve metal substrate 14 shown in FIG. 4.

### DETAILED DESCRIPTION OF THE INVENTION

First, with the reference to FIG. 1, a solid electrolytic capacitor 10 manufactured by applying a manufacturing method according to an embodiment of this invention will be described.

The solid electrolytic capacitor 10 includes a stacked body 13 configured to have a plurality (in the figure, three) capacitor units 11 stacked and joined to each other with a joint material 12. The capacitor units 11 are each configured in common with each other.

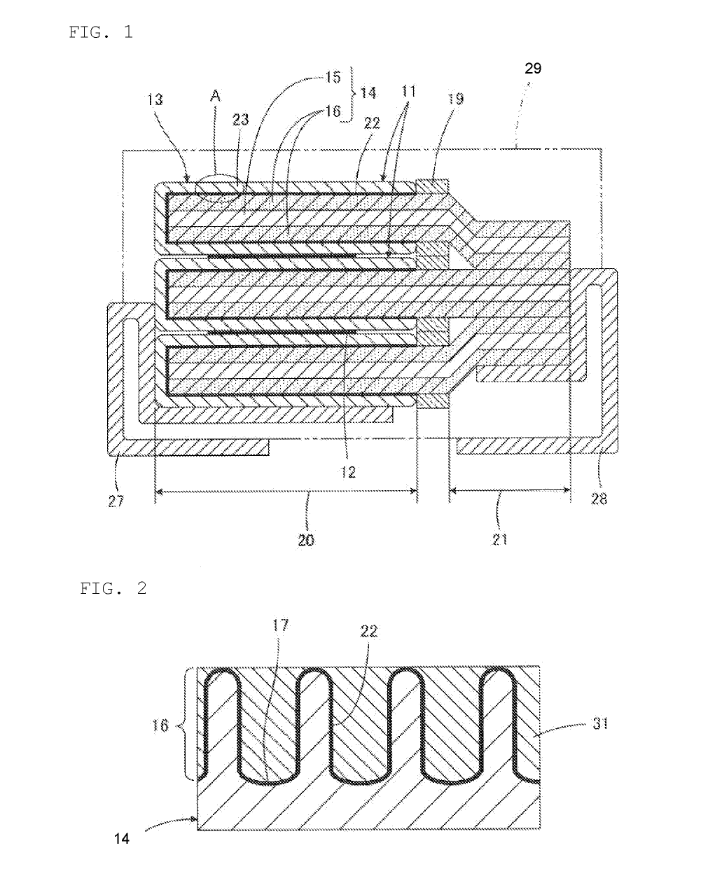

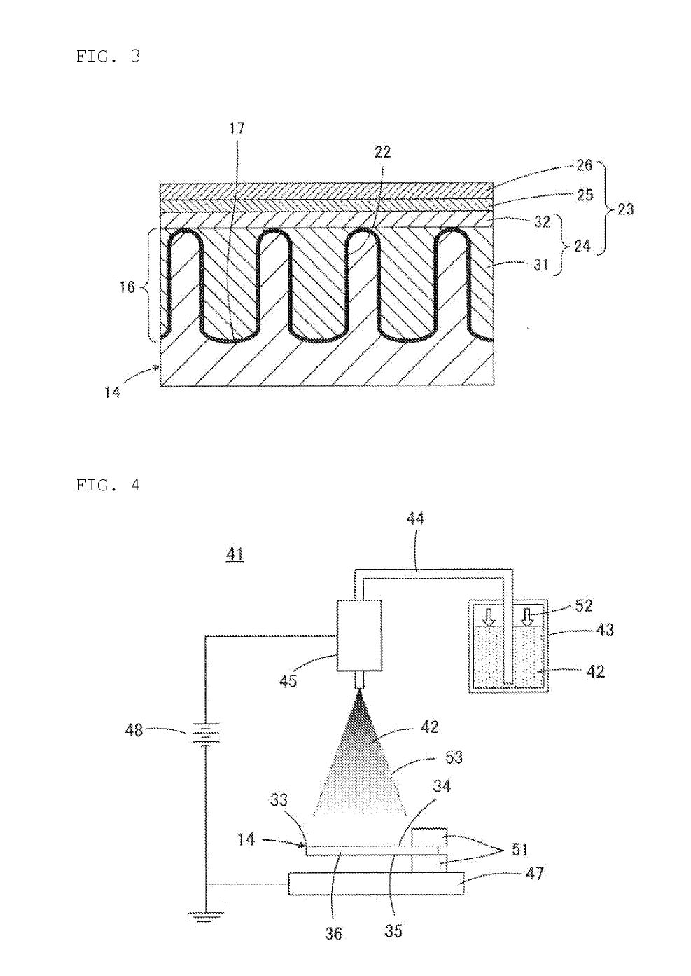

Each capacitor unit 11 includes a valve metal substrate 14 to serve as an anode body. The valve metal substrate 14 is composed of, for example, aluminum foil which has a surface roughened by application of etching, and thereby has a core part 15 and a rough surface part 16 formed along the surface of the core part. The rough surface part 16 has, as schematically shown in FIGS. 2 and 3, a large number of pores 17 formed to have outward openings.

The valve metal substrate 14 has a blocking member 19 disposed thereon. The blocking member 19, which has an electrical insulation property, separates the valve metal substrate 14 into a cathode region 20, which is a region for a cathode, and an anode region 21.

On the surface of at least the cathode region 20 of the valve metal substrate 14, a dielectric coating film 22 (indicated by a bold line in FIGS. 1 through 3) is formed. The dielectric coating film 22 is formed by, for example, oxidizing the surface of the valve metal substrate 14.

On the dielectric coating film 22, a cathode-side functional layer 23 is formed. The cathode-side functional layer 23 is shown as one layer in FIG. 1, but as shown in FIG. 3, composed of an electrically conductive polymer layer 24, a carbon layer 25 thereon, and a silver layer 26 thereon. These layers 24 to 26 are formed by applying respectively corresponding raw material solutions, and the blocking member 19 provided on the rough surface part 16 blocks the penetration of the raw material solutions through the rough surface part 16, thereby preventing the raw material solutions from entering the anode region 21 through the rough surface part 16.

The three valve metal substrates 14 provided with the blocking member 19 and the cathode-side functional layer 23 respectively constitute the capacitor units 11, and the three capacitor units 11 are stacked, and joined to each other with the joint material 12 to constitute the stacked body 13.

To the cathode region 20 in the stacked body 13, more particularly, the silver layer 26 of the cathode-side functional layer 23, a cathode external terminal 27 is connected. On the other hand, in the anode region 21 in the stacked body 13, respective ends of the three valve metal substrates 14 are collected so as to provide continuity. Further, an anode external terminal 28 is connected to ends of the valve metal substrates 14 at the side of the anode region 21. In addition, an exterior resin 29 composed of, for example, an epoxy resin (the outline indicated by an imaginary line in FIG. 1) is formed so as to cover the stacked body 13.

Next, a method for manufacturing the solid electrolytic capacitor 10 described above will be described.

First, aluminum foil with a thickness of, for example, 100 μm is prepared to serve as the valve metal substrates 14. This aluminum foil is etched to roughen the surface, thereby providing the valve metal substrates 14 including the core part 15 and the rough surface part 16 formed along the surface of the core part.

Next, the valve metal substrates 14 are subjected to anodization treatment, thereby oxidizing the surfaces of the valve metal substrates 14, thereby forming the dielectric coating film 22 of, for example, an aluminum oxide.

Next, the blocking member 19 is disposed on the rough surface parts 16 of the valve metal substrates 14. When the blocking member 19 is composed of, for example, a thermosetting resin, respective steps of resin application, drying, and thermal curing are carried out.

Next, a step of forming the electrically conductive layer 24 is carried out so as to cover the cathode region 20 of the valve metal substrates 14 with the dielectric coating film 22 interposed therebetween. For example, pyrrole, aniline, or thiophene, or a derivative thereof is used as a monomer for polymerization in order to obtain the electrically conductive polymer constituting the electrically conductive polymer layer 24.

The step of forming the electrically conductive polymer layer 24 is a feature of this invention, and carried out in two stages of: a first step of, as shown in FIG. 2, forming a first electrically conductive polymer layer 31 on the dielectric coating film 22 so as to fill at least the pores 17 of the rough surface part 16; and a second step of, as shown in FIG. 3, forming a second electrically conductive polymer layer 32 so as to cover the cathode region 20 of the valve metal substrates 14 with the first electrically conductive polymer layer 31 formed thereon.

In the first step, a monomer solution and an oxidant solution are applied onto the valve metal substrates 14 with the use of, for example, a dipping method, and the monomer is then subjected to polymerization by a chemical oxidative polymerization method, thereby forming the first electrically conductive polymer layer 31.

It is to be noted that because the first electrically conductive polymer layer 31 is formed by applying a dipping method, it is difficult to provide the layer as a uniform thin layer under the influence of gravity and surface tension as described previously. In particular, on an edge part 33 (FIG. 4) of the valve metal substrate 14, the first electrically conductive polymer layer 31 is less likely to be formed to have a desired thickness.

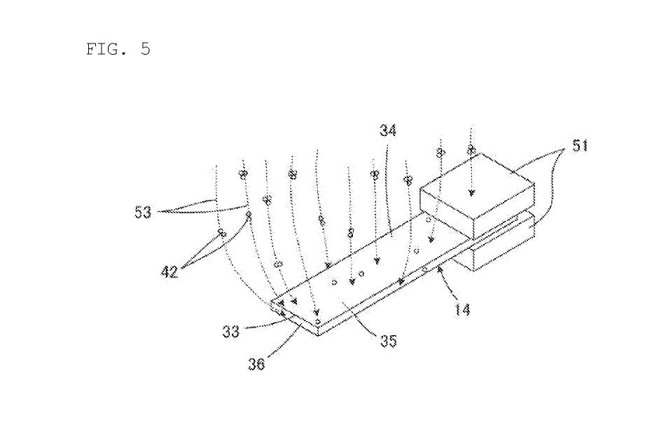

Next, in the second step, the second electrically conductive polymer layer 32 is formed. In order to form the second electrically conductive polymer layer 32, a film formation system 41 is used as shown in FIG. 4. The illustration of the blocking member 19 and first electrically conductive polymer layer 31 provided on the valve metal substrate 14 is omitted in FIG. 4 and FIG. 5 as will be described later.

Referring to FIG. 4, the film formation system 41 includes a storage tank 43 that houses an application material 42 which can serve as the second electrically conductive polymer layer 32. The tank 43 is connected to a discharge nozzle 45 through a supply pipe 44.

On the other hand, a stage 47 is provided to be opposed to the discharge nozzle 45. On the stage 47, as an object on which the second electrically conductive polymer layer 32 is to be formed, the valve metal substrate 14 with the first electrically conductive polymer layer 31 (not shown in FIG. 4) formed is disposed with a principal surface 34 toward the discharge nozzle 45. The valve metal substrate 14 is also shown in FIG. 5. The valve metal substrate 14 is covered with a mask 51 in the region other than a region on which the second electrically conductive polymer layer 32 is to be formed. The stage 47 is preferably composed of an electrically conductive material.

A pulse voltage, a direct-current voltage, or an alternating-current voltage from a power source 48 is applied to the application material 42 passing through the discharge nozzle 45. As just described, the second electrically conductive polymer layer 32 is formed with the voltage applied.

More specifically, in the condition mentioned above, the internal pressure of the storage tank 43 is increased as indicated by arrows 52. Thus, the application material 42 in the storage tank 43 is supplied through the supply pipe 44 to the discharge nozzle 45 with a voltage applied thereto, thereby charging the application material 42. Lines of electric force 53 are generated from the charged application material 42. The application material 42 is discharged from the discharge nozzle 45 toward the valve metal substrate 14.

The application material 42 repeats, while traveling in the air along the lines of electric force 53, fission (Rayleigh fission) due to Coulomb repulsion, thereby turning into a spray. Therefore, the surface area of the application material 42 is further increased with each fission, and thus, drying of the application material 42 proceeds, thereby accelerating the evaporation of a liquid component such as a medium or a solvent contained in the application material 42.

As a result, the application material 42 is, in adhering to the surface of the valve metal substrate 14, dried to the extent that the fluidity is almost lost. Therefore, no surface tension substantially acts on the application material 42, and the application material 42 is thus not concentrated on any particular part of the valve metal substrate 14, but can be thus applied thinly and uniformly onto the valve metal substrate 14. FIG. 5 schematically illustrates the lines of electric force 53 generated by the charged application material 42. The charged application material 42 adheres to the valve metal substrate 14 along the lines of electric force 53. In this regard, the lines of electric force 53 have a tendency to be concentrated on, in particular, the edge part 33 of the valve metal substrate 14, and the application material 42 can be thus allowed to adhere uniformly, also including the edge part 33.

On the other hand, as shown in FIGS. 4 and 5, the anode region 21 of the valve metal substrate 14 is covered with the mask 51, and the application material 42 thus fails to reach the valve metal substrate 14 in the part covered with the mask 51.

In this way, the second electrically conductive polymer layer 32 which has a small uniform thickness is formed to continuously extend on one principal surface 34 of the valve metal substrate 14 and three end surfaces 36 adjacent to the principal surface 34 with the edge part 33 interposed therebetween.

In the step mentioned above, the application material 42 also tries to wrap around the other principal surface 35 opposed to the principal surface 34 of the valve metal substrate 14, but not enough to cover surface 35. Thus, the valve metal substrate 14 on the stage 47 is next turned upside down so that the principal surface 35 is directed to the discharge nozzle 45, and in this condition, the same step as the above-mentioned step of forming the second electrically conductive polymer layer 32 is repeated.

In this way, the electrically conductive polymer layer 24 is formed which is composed of the first and second electrically conductive polymer layers 31 and 32.

It is to be noted that the application material 42 which can serve as the second electrically conductive polymer layer 32 may be a dispersion of or a solution of an electrically conductive polymer, or may be a material before polymerization, i.e., multiple types of raw materials (a monomer, an oxidant, a dopant, and a solvent) for producing an electrically conductive polymer by a chemical oxidative polymerization method. In the latter case, typically, the multiple types of raw materials mixed are housed in one storage tank 43. Therefore, a reaction is initiated in the storage tank 43. Instead, with the use of a plurality of storage tanks, multiple types of raw materials for producing an electrically conductive polymer by a chemical oxidative polymerization method may be separately housed respectively in the tanks, and the multiple types of raw materials may be discharged respectively from different discharge nozzles, and mixed on the valve metal substrate 14. When the application material 42 is not subjected to polymerization, there is a need to create an environment for the polymerization reaction in the formation system 41, and there can be separately a need for a cleaning step for removing the unreacted element.

Next, a repair chemical conversion is carried out such that a carbon paste is applied onto the electrically conductive polymer layer 24, and dried to form the carbon layer 25. Further, a silver paste is applied and dried to form the silver layer 26.

In this way, the capacitor units 11 are obtained. Next, a step of stacking the plurality of capacitor units 11 with the joint material 12 interposed therebetween is carried out. Then, heat treatment or the like for curing the joint material 12 is carried out, thereby providing the stacked body 13.

Thereafter, as shown in FIG. 1, the cathode external terminal 27 is joined so as to be electrically connected to the cathode-side functional layer 23 of the stacked body 13, and on the other hand, the anode external electrode 28 is joined so as to be electrically connected to ends of the valve metal substrates 14 of the stacked body 13 at the side of the anode region 21.

Then, the exterior resin 29 is formed, thereby completing the solid electrolytic capacitor 10.

Next, experimental examples will be described which were carried out for confirming advantageous effects of this invention.

1. Preparation of Sample

Aluminum foil was prepared, and the surface thereof was roughened by etching, thereby providing a valve metal substrate including a core part and a rough surface part formed along the surface of the core part. Then, the valve metal substrate was anodized to form a dielectric coating film.

Next, on the valve metal substrate, a first electrically conductive polymer layer was formed in the following way. First, a cathode region of the valve metal substrate was immersed in a solution with 3,4-ethylenedioxythiophene as a monomer and ethanol as a solvent, and dried. Thereafter, the cathode region of the valve metal substrate was immersed in a solution with a sulfonic acid-based metal salt as an oxidant/dopant and n-butanol as a solvent, subjected to chemical oxidative polymerization while drying for a predetermined period of time, then subjected to immersion cleaning with an alcohol, and dried. Then, these steps were repeated a number of times as shown in the column “Dipping Frequency” of Table 1 below, thereby forming the first electrically conductive polymer layer.

### Examples 1 to 3

Next, for Examples 1 to 3, with a dispersion of an electrically conductive polymer as an application material, this dispersion was charged through the application of a voltage, and applied and dried on the valve metal substrate with the first electrically conductive polymer layer formed, thereby forming a second electrically conductive polymer layer.

More specifically, a water dispersion of poly(3,4-ethylenedioxythiophene)-poly(styrene sulfonic acid) was charged through the application of a voltage, and discharged from a discharge nozzle toward the valve metal substrate with the first electrically conductive polymer layer formed. While an electric field with an electric field intensity of 100 to 1000 kV/m was generated between the discharge nozzle and the valve metal substrate, the charged application material was, with Rayleigh fission, flown to the valve metal substrate along lines of electric force, and dried, thereby forming the second electrically conductive layer.

Next, a carbon paste was applied onto the second electrically conductive polymer layer, and a silver paste was applied thereon, thereby providing a capacitor unit.

Thereafter, solid electrolytic capacitors according to Examples 1 to 3 were obtained by stacking a predetermined number of capacitor units, attaching external terminals, and forming an exterior resin so as to cover the stacked body.

### Examples 4 to 6

On the other hand, for Examples 4 to 6, multiple types of raw materials for producing an electrically conductive polymer by a chemical oxidative polymerization method were, as an application material, charged through the application of a voltage, applied onto the valve metal substrate with the first electrically conductive polymer layer formed and subjected to chemical oxidative polymerization, and dried to form a second electrically conductive polymer layer.

More specifically, 3,4-ethylenedioxythiophene used as a monomer, a sulfonic acid-based metal salt as an oxidant/dopant, n-butanol as a solvent were mixed as an application material. This application material was charged through the application of a voltage, and discharged from a discharge nozzle to the valve metal substrate with the first electrically conductive polymer layer formed. While an electric field with an electric field intensity of 100 to 1000 kV/m was generated between the discharge nozzle and the valve metal substrate, the charged application material was, with Rayleigh fission, flown to the valve metal substrate along lines of electric force, subjected to chemical oxidative polymerization for a predetermined period of time, and immersion cleaning with alcohol, and dried, thereby forming the second electrically conductive layer.

Next, a repair chemical conversion was carried out, a carbon paste was applied onto the second electrically conductive layer, and a silver paste was applied thereon, thereby providing a capacitor unit.

Thereafter, solid electrolytic capacitors according to Examples 4 to 6 were obtained by stacking a predetermined number of capacitor units, attaching external terminals, and forming an exterior resin so as to cover the stacked body.

### Comparative Examples 1 to 4

For Comparative Examples 1 to 4, without carrying out the step of forming the second electrically conductive layer, a repair chemical conversion was carried out after the formation of the first electrically conductive layer, a carbon paste was applied onto the first electrically conductive layer, and a silver paste was applied thereon, thereby providing a capacitor unit.

Thereafter, solid electrolytic capacitors according to Comparative Examples 1 to 4 were obtained by stacking a predetermined number of capacitor units, attaching external terminals, and forming an exterior resin so as to cover the stacked body.

2. Evaluation

The solid electrolytic capacitors according to each of Examples 1 to 6 and Comparative Examples 1 to 4 as samples were evaluated for each item shown in Table 1.

The “Electrostatic Capacitance” and the “ESR” were measured with the use of an LCR meter (E4980A from agilent). The “Electrostatic Capacitance” and the “ESR” respectively represent values at 120 Hz and 100 kHz. The number of measurement samples was five, and the average value for the measurements is shown in Table 1.

The “Upper Part Thickness on Principal Surface” and the “Lower Part Thickness on Principal Surface” refer to the thicknesses of the electrically conductive polymer layer on the principal surface of the valve metal substrate, which were measured with the use of a degimatic indicator (IDC-112B from Mitutoyo Corporation). With respect to the total thickness of the first and second electrically conductive polymer layers in Examples 1 to 6, and the thickness of only the first electrically conductive polymer layer in Comparative Examples 1 to 4, the electrically conductive polymer layer was divided along the dipping direction into three equal parts of an upper part, an intermediate part, and a lower part, and the thickness of the upper part along the dipping direction was regarded as the “Upper Part Thickness on Principal Surface”, whereas the thickness of the lower part along the dipping direction was regarded as the “Lower Part Thickness on Principal Surface”. The measurement locations were three for each of the upper part and lower part, whereas the number of measurement samples was three, and the average value for the measurements is shown in Table 1.

For the “Edge Part Thickness”, the valve metal substrate was embedded in a resin, polished to expose a cross section, and the cross section was observed with a microscope to measure the thickness of the electrically conductive polymer layer on an edge part. The number of measurement samples was two, and the average value for the measurements is shown in Table 1.

The “Lower Part Thickness/Upper Part Thickness” represents the ratio of the “Upper Part Thickness on Principal Surface” divided by the “Lower Part Thickness on Principal Surface”.

For obtaining the “Leakage Current Percent Defective after Formation”, a rated direct-current voltage was applied for 2 minutes to the solid electrolytic capacitor as a sample through a protective resistance, and the current value after the application was measured. In this regard, the value of leakage current (LC) less than 0.04 CV was determined to have passed, whereas the value of 0.04 CV or more was determined to have failed. It is to be noted that the “C” in “0.04 CV” refers to an electrostatic capacitance value, whereas the “V” therein refers to a rated voltage. Then, the number of determination samples was 100, and the ratio of the number of samples determined to have failed was regarded as a percent defective.

TABLE 1

| | Exam- | Exam- | Exam- | | | | Comparative | Comparative | Comparative | Comparative |
|---|---|---|---|---|---|---|---|---|---|---|
| | ple 1 | ple 2 | ple 3 | Example 4 | Example 5 | Example 6 | Example 1 | Example 2 | Example 3 | Example 4 |
| Dipping Frequency | 4 | 5 | 6 | 4 | 5 | 6 | 4 | 5 | 6 | 7 |
| Second Electrically | Yes | Yes | Yes | Yes | Yes | Yes | No | No | No | No |
| Conductive Polymer Layer | | | | | | | | | | |
| Electrostatic | 53 | 55 | 54 | 54 | 55 | 55 | 54 | 55 | 55 | 54 |
| Capacitance (μF) | | | | | | | | | | |
| ESR(mΩ) | 13 | 13 | 11 | 15 | 14 | 14 | 15 | 16 | 16 | 16 |
| Upper Part Thickness on | 7 | 12 | 15 | 8 | 11 | 15 | 5 | 8 | 12 | 18 |
| Principal Surface (μm) | | | | | | | | | | |
| Lower Part Thickness on | 9 | 16 | 21 | 10 | 14 | 20 | 7 | 12 | 19 | 30 |
| Principal Surface (μm) | | | | | | | | | | |
| Edge Part Thickness (μm) | 8 | 13 | 17 | 9 | 11 | 14 | 1 | 2 | 2 | 3 |
| Lower Part Thickness/ | 1.29 | 1.33 | 1.40 | 1.25 | 1.27 | 1.33 | 1.40 | 1.50 | 1.58 | 1.67 |
| Upper Part Thickness | | | | | | | | | | |
| Leakage Current Percent | 7 | 3 | 1 | 5 | 2 | 1 | 80 | 70 | 60 | 50 |
| Defective after | | | | | | | | | | |
| Formation (%) | | | | | | | | | | |

As shown in Table 1, as for the “Electrostatic Capacitance” and the “ESR”, Comparative Examples 1 to 4 have achieved results nearly equivalent to those in Examples 1 to 6. However, in Comparative Examples 1 to 4, the increase in “Dipping Frequency” to four times, five times, six times, or seven times increased the “Upper Part Thickness on Principal Surface” and the “Lower Part Thickness on Principal Surface”, but hardly increased the “Edge Part Thickness”. In addition, in Comparative Examples 1 to 4, the “Leakage Current Percent Defective after Formation” is high. This is presumed to be because stress applied in the step of forming an exterior resin caused damage to the dielectric coating film, due to the small “Edge Part Thickness”.

In contrast, in Examples 1 to 6, the “Edge Part Thickness” is significantly larger as compared with Comparative Examples 1 to 4. This is obviously due to the formation of the second electrically conductive polymer layer. In addition, the “Lower Part Thickness/Upper Part Thickness” has smaller values totally in Examples 1 to 6 as compared with Comparative Examples 1 to 4, and the differences among the “Upper Part Thickness on Principal Surface”, “Lower Part Thickness on Principal Surface”, and “Edge Part Thickness” are smaller in Examples 1 to 6 as compared with Comparative Examples 1 to 4. From the foregoing, the second electrically conductive polymer layers formed in Examples 1 to 6 can be considered to contribute the formation of uniform and thin electrically conductive polymer layers.

It is to be noted that no substantial difference was found between Examples 1 to 3 and Examples 4 to 6.

### DESCRIPTION OF REFERENCE SYMBOLS

10 Solid electrolytic capacitor
14 Valve metal substrate
15 Core part
16 Rough surface part
20 Cathode region
21 Anode region
22 Dielectric coating film
23 Cathode-side functional layer
24 Electrically conductive polymer layer
25 Carbon layer
26 Silver layer
27 Cathode external terminal
28 Anode external terminal
29 Exterior resin
31 First electrically conductive polymer layer
32 Second Electrically Conductive Polymer Layer
33 Edge part
41 Formation system
42 Application material
45 Discharge nozzle
51 Mask
53 Line of electric force

1. A method for manufacturing a solid electrolytic capacitor, the method comprising:
providing a valve metal substrate, the valve metal substrate having a surface with a plurality of pores;
forming a dielectric coating on at least part of the surface of the valve metal substrate; and
forming a first electrically conductive polymer layer on the dielectric coating film to fill at least a pore of the plurality of pores of the surface; and
preparing an application material for a second electrically conductive polymer layer;
disposing the valve metal substrate with the first electrically conductive polymer layer formed thereof so as to be opposed to a discharge nozzle for discharging the application material;
generating an electric field between the discharge nozzle and the valve metal substrate; and
discharging the application material from the discharge nozzle during generation of the electric field so as to cause charged application material to travel along a line of electric force toward the valve metal substrate and form the second electrically conductive polymer layer to cover the first electrically conductive polymer layer.

2. The method for manufacturing a solid electrolytic capacitor according to claim 1, wherein the application material is a dispersion of or a solution of an electrically conductive polymer.

3. The method for manufacturing a solid electrolytic capacitor according to claim 1, wherein the application material comprises multiple types of raw materials for producing an electrically conductive polymer by chemical oxidative polymerization.

4. The method for manufacturing a solid electrolytic capacitor according to claim 1, further comprising etching aluminum foil to create the plurality of pores on the surface of the valve metal substrate.

5. The method for manufacturing a solid electrolytic capacitor according to claim 1, wherein the dielectric coating is formed by an anodization treatment.

6. The method for manufacturing a solid electrolytic capacitor according to claim 1, wherein the first electrically conductive polymer layer is formed by applying a monomer solution and an oxidant solution onto the valve metal substrates, and polymerizing the monomer by chemical oxidative polymerization.

7. The method for manufacturing a solid electrolytic capacitor according to claim 1, further comprising applying a carbon paste onto the second electrically conductive polymer layer to form a carbon layer.

8. The method for manufacturing a solid electrolytic capacitor according to claim 7, further comprising applying a silver paste onto the carbon layer to form a silver layer.
